(19) United States
(12) Patent Application Publication
(10) Pub. No.: US 2015/0089913 A1
(43) Pub. Date: Apr. 2, 2015

(54) Harvesting machine for picking up fruit on the ground

(71) Applicant: Eric Maisonneuve, St-Amable (CA)

(72) Inventor: Eric Maisonneuve, St-Amable (CA)

(21) Appl. No.: 14/044,102

(22) Filed: Oct. 2, 2013

(51) Int. Cl. A01D 51/00; A01D 75/00

(52) U.S. Cl. CPC A01D 51/00; A01D 75/00
USPC 56/14.7; 56/328.1

(57) ABSTRACT

A harvesting machine for picking up fruit on the ground has a structural frame for supporting elements of the harvesting machine including a first rotating brush adapted to be held at ground level, having an axis of rotation perpendicular to the ground level, and adapted to push fruit towards a main sweeping brush. A main sweeping brush having an axis of rotation parallel to the ground level, and adapted to push fruit upwards and onto a first conveyer. A first conveyer adapted to transport the fruit in a horizontal direction to a second conveyer. A second conveyer adapted to transport the fruit in an upward direction to thereby be dropped within a collector bin and transported to a desired location.

This application claims priority based on request GB1217728.3 filed Oct. 3, 2012

### FIELD OF THE INVENTION

The present invention relates generally farming but more particularly to a harvesting machine for picking up fruit on the ground.

### BACKGROUND OF THE INVENTION

There are many types of machines that have been developed for picking up fruit that have already fallen from the trees but there is still room for improvement.

### SUMMARY OF THE INVENTION

In view of the foregoing disadvantages inherent in the known devices now present in the prior art, the present invention, which will be described subsequently in greater detail, is to provide objects and advantages which are:

To provide for a machine that efficiently picks up fruit off the ground.

In order to do so, the invention consists in a structural frame for supporting elements of the harvesting machine including a first rotating brush adapted to be held at ground level, having an axis of rotation perpendicular to the ground level, and adapted to push fruit towards a main sweeping brush. A main sweeping brush having an axis of rotation parallel to the ground level, and adapted to push fruit upwards and onto a first conveyer. A first conveyer adapted to transport the fruit in a horizontal direction to a second conveyer. A second conveyer adapted to transport the fruit in an upward direction to thereby be dropped within a collector bin and transported to a desired location.

The improved harvesting machine further includes a blower member adapted to blow unwanted debris off and away from the fruit before the fruit proceeds to a chute member. A chute member adapted to guide the fruit away from the blower member and down into the collector bin.

A pair of forks extend outwardly from a side of the structural frame opposite a side as to which the first rotating brush is attached, and adapted such that the collector bin can be held in an upright and stable position for collecting the fruit.

The improved harvesting machine further includes at least one wheel member attached to a bottom portion of the structural frame and adjacent the main sweeping brush, the at least one wheel member being adapted to hold the structural frame and the main sweeping brush a desired level above the ground even when the ground is uneven.

The first rotating brush is formed having a circular cross-section perpendicular to the axis of rotation; and the main sweeping brush formed having an elongated rectangular cross-section parallel to its axis of rotation.

The second conveyer is placed at an angle less than 90 degrees from the axis of rotation of the main sweeping brush.

Two main wheel members attached on opposite sides from one another on the structural frame, and wherein the two main wheel members attached adjacent opposite ends of the main sweeping brush, wherein the two main wheel members are adapted to hold and roll the harvesting machine along and at a proper height and stable position above the ground.

The improved harvesting machine is connected to a motorized vehicle by way of a standard three point hitch adapted to hold and push the harvesting machine along desired paths.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Side view of the invention.

FIG. 2 Top view of the invention.

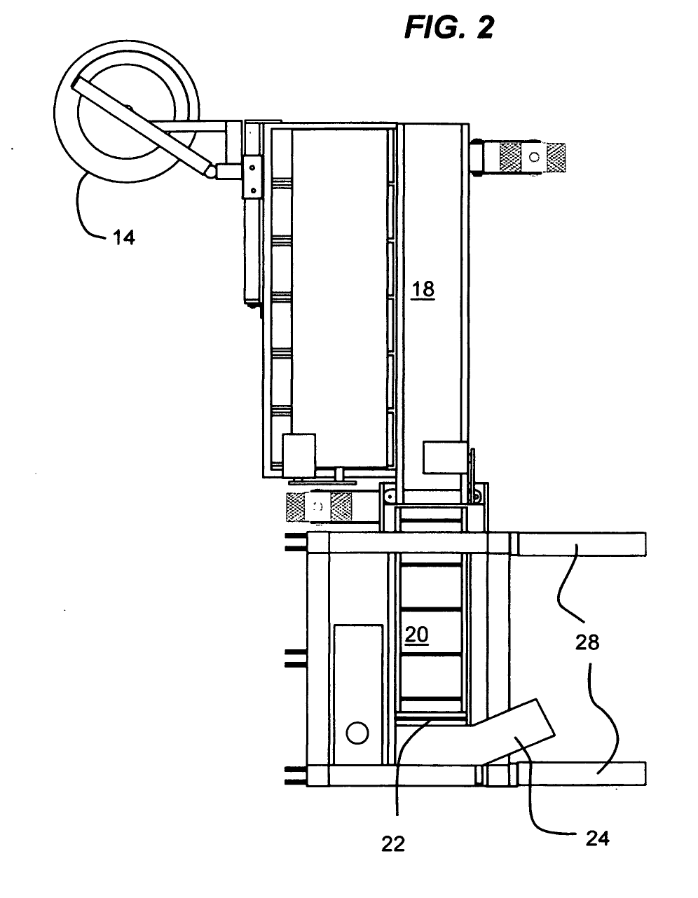

FIG. 3 Front view of the invention.

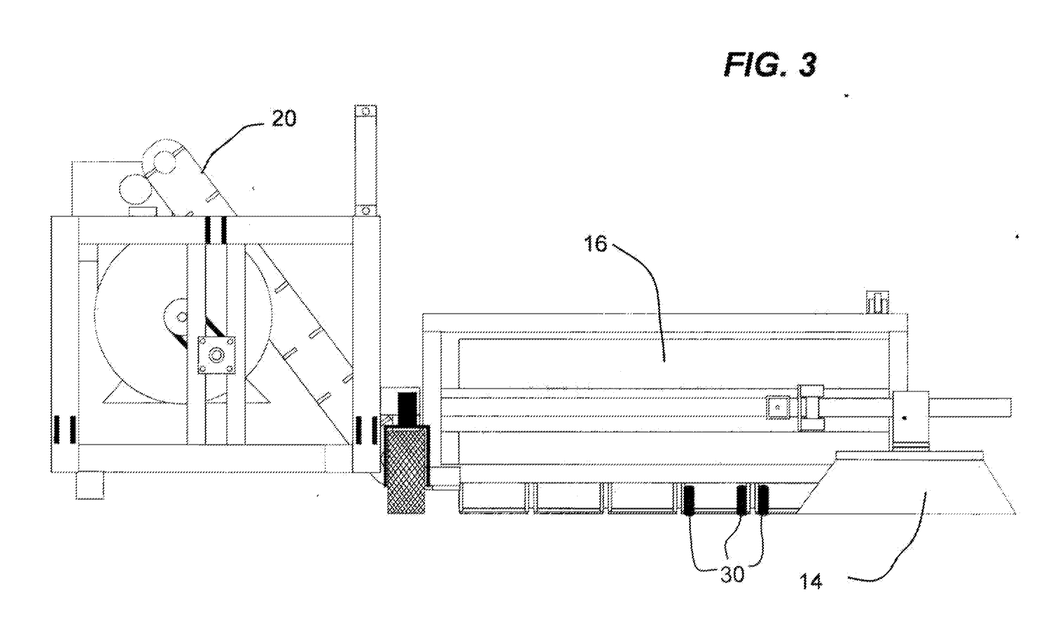

FIGS. 4a-d Side view of the invention, showcasing type 1, type 2, type 3 and top view of all three types.

FIGS. 5a-b Side views of two variants showing alternate fruit carrying means.

FIG. 6 Top view of an alternate fruit sweeper.

### DETAILED DESCRIPTION OF THE PREFERRED EMBODIMENT

A harvesting machine (10) for picking up fruit on the ground has a structural frame (12) for supporting several elements such as a first rotating brush (14) rotating around an axis perpendicular to the ground, and located substantially at ground level, and which picks up fruit (not shown) off the edge and directs the fruit to a main sweeping brush (16) having an axis of rotation parallel to the ground and which brings the fruit to a first conveyor (18) running horizontally. From there, the fruit is carried upward by way of a second conveyor (20) running in an upward orientation.

The first rotating brush (14) is formed having a circular cross-section perpendicular to the axis of rotation, and the main sweeping brush (16) is formed having an elongated rectangular cross-section parallel to its axis of rotation.

A blower member(22) blows off debris (not shown) before the fruit falls into a chute member (24) and then into a bin (not shown). The bin is supported by a pair of forks (28) extending outwardly from the side of the frame (12).

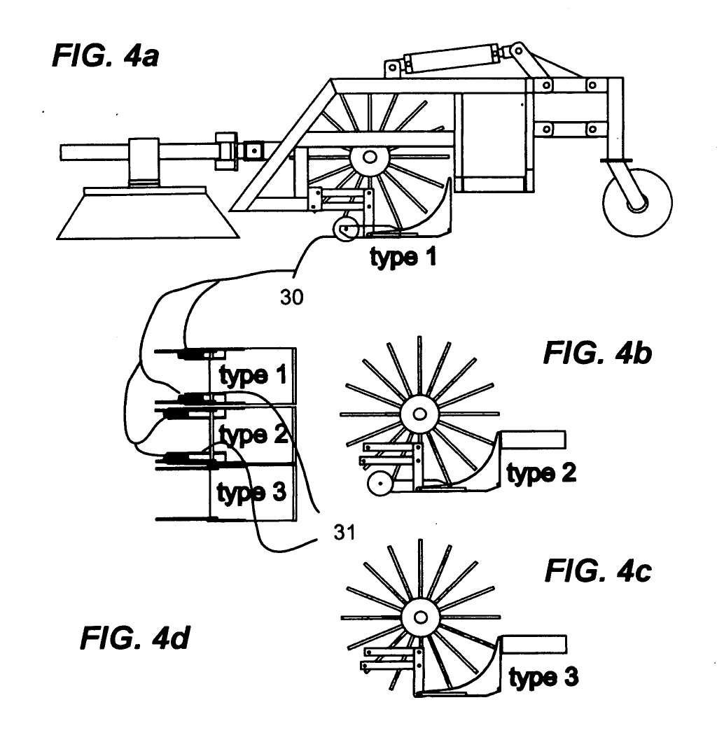

There are variants to the invention when it comes to its use or non use of a wheel (30) that allows to follow the terrain when there it is uneven. The wheel (30) can have two configuration known as type 1 and type 2 as shown in FIG. 4, and wherein type two has longer attachment means (31) than type 1. Type 3 is when the wheel (30) is not used.

There are two main wheel members (32) attached on opposite sides from one another on the structural frame (12), that are attached adjacent opposite ends of the main sweeping brush. The two main wheel members (32) are adapted to hold and roll the harvesting machine (10) along and at a proper height and stable position above the ground.

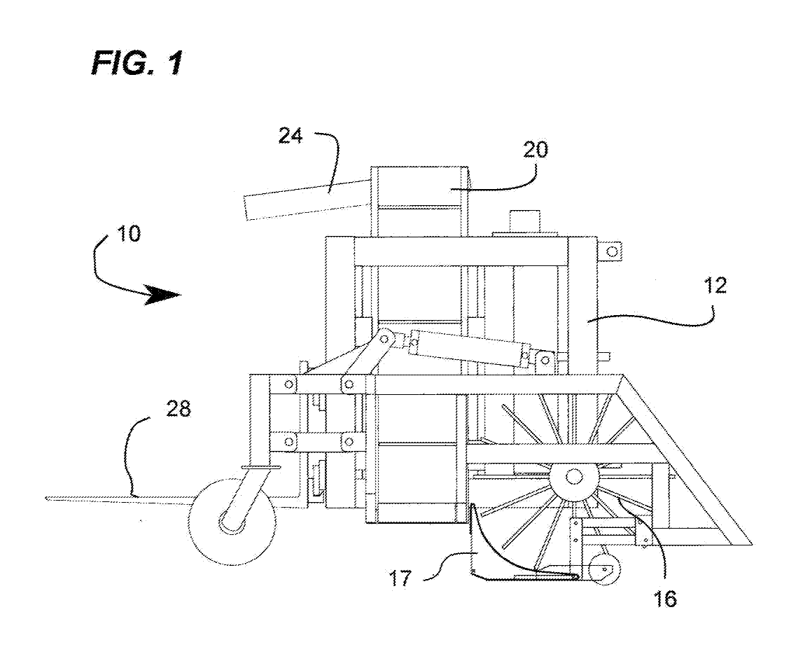

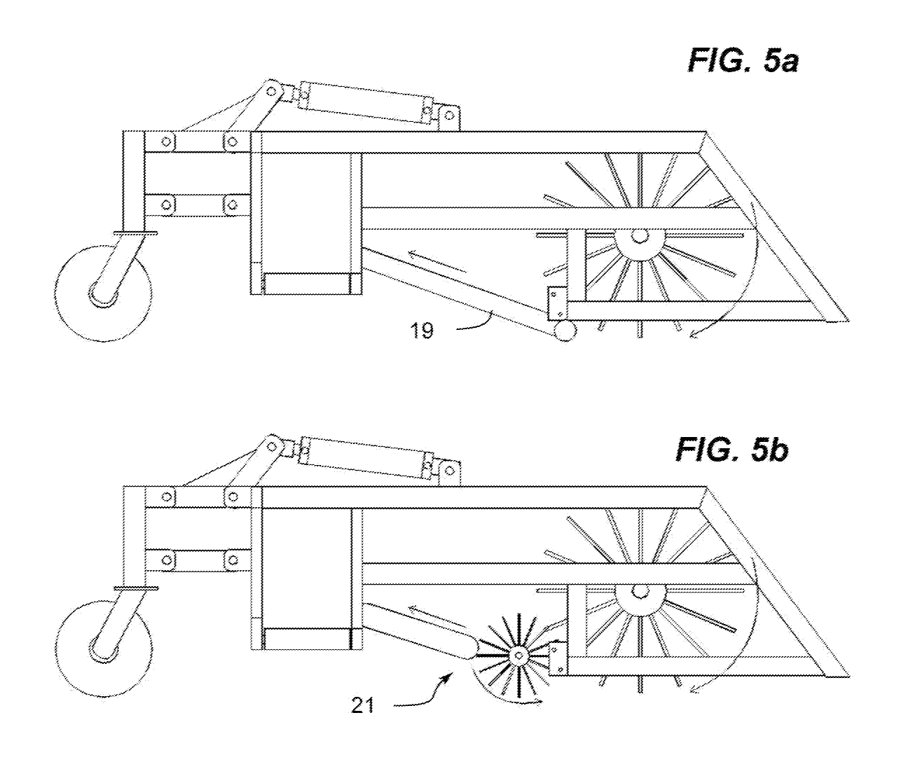

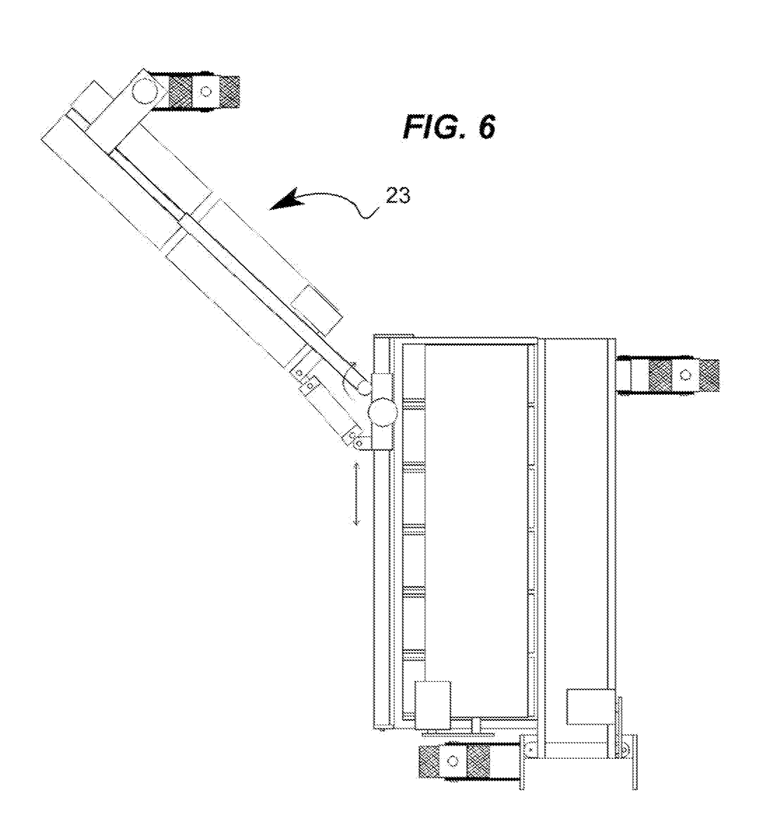

Other variants are shown in FIG. 5a where the slide (17) of FIG. 1 is replaced by a threadmill (19) or a combination paddle wheel threadmill (21) as in FIG. 5b. In FIG. 6 an elongated side sweeper (23) provides for a wider fruit pick-up area.

Typically, the invention works in combination with a motorized farm vehicle such as a farm tractor (not shown) to which it is connected to by way of a standard three point hitch attachment (not shown).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An improved harvesting machine for picking up fruit laying on the ground, said harvesting machine comprising a structural frame for supporting elements of said harvesting machine including a first rotating brush adapted to be held at ground level, having an axis of rotation perpendicular to said ground level, and adapted to push fruit towards a main sweeping brush; a main sweeping brush having an axis of rotation parallel to said ground level, and adapted to push fruit upwards and onto a first conveyer; a first conveyer adapted to transport said fruit in a horizontal direction to a second conveyer; a second conveyer adapted to transport said fruit in an upward direction to thereby be dropped within a collector bin and transported to a desired location.

2. The improved harvesting machine of claim 1, further including a blower member adapted to blow unwanted debris off and away from said fruit before said fruit proceeds to a chute member; and a chute member adapted to guide said fruit away from said blower member and down into said collector bin.

3. The improved harvesting machine of claim 1, further including a pair of forks extending outwardly from a side of said structural frame opposite a side as to which said first rotating brush is attached, and adapted such that said collector bin can be held in an upright and stable position for collecting said fruit.

4. The improved harvesting machine of claim 1, further including at least one wheel member attached to a bottom portion of said structural frame and adjacent said main sweeping brush, said at least one wheel member being adapted to hold said structural frame and said main sweeping brush a desired level above said ground even when said ground is uneven.

5. The improved harvesting machine of claim 1, wherein said first rotating brush is formed having a circular cross-section perpendicular to said axis of rotation; and said main sweeping brush formed having an elongated rectangular cross-section parallel to its axis of rotation.

6. The improved harvesting machine of claim 1, wherein said second conveyer is placed at an angle less than 90 degrees from said axis of rotation of said main sweeping brush.

7. The improved harvesting machine of claim 1, further including two main wheel members attached on opposite sides from one another on said structural frame, and wherein said two main wheel members attached adjacent opposite ends of said main sweeping brush, wherein said two main wheel members are adapted to hold and roll said harvesting machine along and at a proper height and stable position above said ground.

8. The improved harvesting machine of claim 1, further including a three point hitch attachment connected to a motorized vehicle adapted to hold and push said harvesting machine along desired paths.

9. A combination of a motorized farm vehicle and an improved harvesting machine for picking up fruit laying on the ground, said motorized farm vehicle including an attachment portion adapted to releasably connect a harvesting machine thereto; and said harvesting machine comprising a structural frame for supporting elements of said harvesting machine including a first rotating brush adapted to be held at ground level, having an axis of rotation perpendicular to said ground level, and adapted to push fruit towards a main sweeping brush; a main sweeping brush having an axis of rotation parallel to said ground level, and adapted to push fruit upwards and onto a first conveyer; a first conveyer adapted to transport said fruit in a horizontal direction to a second conveyer; a second conveyer adapted to transport said fruit in an upward direction to thereby be dropped within a collector bin and transported to a desired location; and wherein said harvesting machine further includes at least one connector member adapted to releasably connect said harvesting machine to said motorized vehicle to hold and push said harvesting machine along desired paths.

10. The combination of claim 9, further including a blower member adapted to blow unwanted debris off and away from said fruit before said fruit proceeds to a chute member; and a chute member adapted to guide said fruit away from said blower member and down into said collector bin.

11. The combination of claim 9, further including a pair of forks extending outwardly from a side of said structural frame opposite a side as to which said first rotating brush is attached, and adapted such that said collector bin can be held in an upright and stable position for collecting said fruit.

12. The combination of claim 9, further including at least one wheel member attached to a bottom portion of said structural frame and adjacent said main sweeping brush, said at least one wheel member being adapted to hold said structural frame and said main sweeping brush a desired level above said ground even when said ground is uneven.

13. The combination of claim 9, wherein said first rotating brush is formed having a circular cross-section perpendicular to said axis of rotation; and said main sweeping brush formed having an elongated rectangular cross-section parallel to its axis of rotation.

14. The combination of claim 9, wherein said second conveyer is placed at an angle less than 90 degrees from said axis of rotation of said main sweeping brush.

15. The combination of claim 9, further including two main wheel members attached on opposite sides from one another on said structural frame, and wherein said two main wheel members attached adjacent opposite ends of said main sweeping brush, wherein said two main wheel members are adapted to hold and roll said harvesting machine along and at a proper height and stable position above said ground.
